(19) United States
(12) Patent Application Publication
(10) Pub. No.: US 2018/0149080 A1
(43) Pub. Date: May 31, 2018

(54) STUD-ENGAGING ENGINE COVER POCKET PLUG

(71) Applicant: Ford Global Technologies, LLC, Dearborn, MI (US)

(72) Inventors: Christopher William Newman, Farmington Hills, MI (US); Gary Nola, Saline, MI (US)

(21) Appl. No.: 15/363,560

(22) Filed: Nov. 29, 2016

(51) Int. Cl. F02B 77/00

(52) U.S. Cl. CPC F02B 77/005

(57) ABSTRACT

An engine cover assembly including a stud-engaging engine cover pocket plug is disclosed. The plug conceals the cover fastener assembly. The plug includes a concealing cover and a stud attachment assembly extending from the cover. The assembly comprises a bridge, a pair of spaced apart legs attached to the bridge, and a base having a stud-retaining aperture. The bridge, the pair of spaced apart legs, and the base define a parallelogram such as a rectangle. The base of the stud attachment assembly has a long axis. According to one embodiment, the base includes a pair of opposed slots extending from the stud-retaining aperture in opposite directions along the long axis of the base. According to another embodiment, the base also includes a pair of opposed slots extending from the stud-retaining aperture. However, each slot extends in a direction that is perpendicular to the long axis of the base.

### TECHNICAL FIELD

The disclosed inventive concept relates generally to covers for vehicle engines and to systems for attaching covers to the engine. More particularly, the disclosed inventive concept relates to engine covers and a system for maintaining a finished and clean look. A threaded stud is attached to the engine. A nut is fitted to the threaded stud to hold the cover to the engine. A stud-engaging engine cover pocket plug is fitted into a fastener pocket formed in the cover and is attached to the threaded stud, thereby concealing the fastener assembly from view.

### BACKGROUND OF THE INVENTION

The engine compartment of the modern vehicle has an appearance that is quite different from that of its predecessors. For decades following the introduction of the motor vehicle, the engine compartment was generally ignored by designers who, instead, focused on the exterior and interior of the vehicle. The engine compartment of the production vehicle (as opposed to the show vehicle) was left entirely to engineers and thus was solely functional.

Nowadays, however, designers are engaged to improve the overall appearance of the engine compartment. The general result of these efforts is the inclusion in the engine compartment of an engine cover that covers at least some of the vehicle's engine. Known covers have a variety of shapes and styles and vary in the degree to which they cover the engine. The engine cover is typically but not exclusively formed from a polymerized material such as soft polyurethane (PUR) foam.

Known methods for attaching the engine cover to the engine itself include fitting stud bolts to strategic locations on the engine, applying appropriate torque to the stud bolts, installing the engine cover having pockets into which the stud bolts are fitted, and running down attachment nuts to secure the engine cover in position. The pockets are formed in the cover to meet the cover's mating component. The pockets are ordinarily wide enough to meet necessary attachment tooling requirements.

The exposed fasteners, such as the nut and stud bolt combination conventionally used to attach the engine cover to the engine, are traditionally left exposed in their respective pockets. The exposed fasteners do not meet current under-hood appearance requirements. Accordingly, a common challenge for the designer of the modern engine cover is the need to combine functionality and serviceability with aesthetics in the relatively small space typically provided in the modern engine compartment. Consideration must therefore be given to ease of installation to maintain competitive assembly costs and ease of removability of the cover while giving assurance that the engine cover effectively provides good aesthetics. Known solutions to attaching the engine cover fail to provide a solution to the challenge faced by exposed fasteners.

As in so many areas of vehicle technology there is always room for improvement related to the design of engine covers and to their methods of installation. A new approach to attaching an engine cover to an engine while maintaining optimum aesthetic appearance is needed to address the problems associated with known arrangements.

### SUMMARY OF THE INVENTION

The disclosed inventive concept provides a convenient, practical and cost-effective solution to the challenge faced by covering mechanical fasteners that hold the engine cover to the engine. The disclosed inventive concept thus provides an ideal solution to the problem of appearance degradation caused by the use of mechanical fasteners.

The arrangement of the disclosed inventive concept includes a stud-engaging engine cover pocket plug for fitting into the pocket of an engine cover to hide the mechanical fastener from view. The concealing plug may be readily installed in the cover pocket and may be easily removed to allow disassembly of the cover fasteners and subsequent removal of the engine cover as needed.

The concealing plug includes a concealing cover and a stud attachment assembly extending from the cover. The assembly comprises a bridge, a pair of spaced apart legs attached to the bridge, and a base having a stud-retaining aperture. The bridge, the pair of spaced apart legs, and the base define a rectangle.

The base of the stud attachment assembly has a long axis. According to one embodiment of the disclosed inventive concept, the base includes a pair of opposed slots extending from the stud-retaining aperture in opposite directions along the long axis of the base. According to another embodiment of the disclosed inventive concept, the base also includes a pair of opposed slots extending from the stud-retaining aperture. However, according to this embodiment, each slot extends in a direction that is perpendicular to the long axis of the base.

A stud-receiving anchor is attached to the engine and a cover-attaching stud is fitted to the anchor. A compression-limiting spacer is placed on the upper surface of the anchor. The engine cover is positioned on the engine such that the cover attaching stud is passed through the stud-passing aperture of the cover. A fastening nut is then threaded onto the cover-attaching stud until it comes into contact with the compression-limiting spacer.

After the fastening nut is fully attached, the concealing plug is inserted without the need for the use of a tool. Removal of the concealing plug can be easily achieved by using a tool for prying the concealing plug out of position, such as by use of a screwdriver or a similar prying tool.

The above advantages and other advantages and features will be readily apparent from the following detailed description of the preferred embodiments when taken in connection with the accompanying drawings.

### BRIEF DESCRIPTION OF THE DRAWINGS

For a more complete understanding of this invention, reference should now be made to the embodiments illustrated in greater detail in the accompanying drawings and described below by way of examples of the invention wherein:

FIG. 1 is a perspective view of an embodiment of a stud-engaging engine cover pocket plug for use with an engine cover according to the disclosed inventive concept;

FIG. 2 is another perspective view of the stud-engaging engine cover pocket plug of FIG. 1;

FIG. 3 is an underside view of the stud-engaging engine cover pocket plug of FIGS. 1 and 2;

FIG. 4 is a perspective view of another embodiment of a stud-engaging engine cover pocket plug for use with an engine cover according to the disclosed inventive concept;

FIG. 5 is an underside view of the stud-engaging engine cover pocket plug of FIG. 4;

FIG. 6 is a top view of a portion of an engine cover illustrating a fastener pocket formed therein in which a fastener can be seen before insertion of the stud-engaging engine cover pocket plug of the disclosed inventive concept;

FIG. 7 is the same view of a portion of an engine cover illustrated in FIG. 6 but showing the stud-engaging engine cover pocket plug of the disclosed inventive concept in place in the fastener pocket; and

FIG. 8 is a sectional view of a portion of an engine cover and its engine cover pocket, a portion of an engine, the fastener arrangement by which the engine cover is attached to the engine, and the stud-engaging engine cover pocket plug of the disclosed inventive concept in place in the engine cover pocket to thereby conceal the engine cover fastener.

### DETAILED DESCRIPTION OF THE PREFERRED EMBODIMENT

In the following figures, the same reference numerals will be used to refer to the same components. In the following description, various operating parameters and components are described for different constructed embodiments. These specific parameters and components are included as examples and are not meant to be limiting.

The accompanying figures illustrate an arrangement for providing a finished and clean look to an engine cover for a vehicle. The fastener-concealing foam plug is readily adapted for any fastener pocket, is inexpensive to produce, and may be readily inserted into and removed from the fastener pocket. It is to be understood that the illustrated foam plug as illustrated is not to be restricted to the configuration shown in the figures which is intended as being illustrative without being limiting.

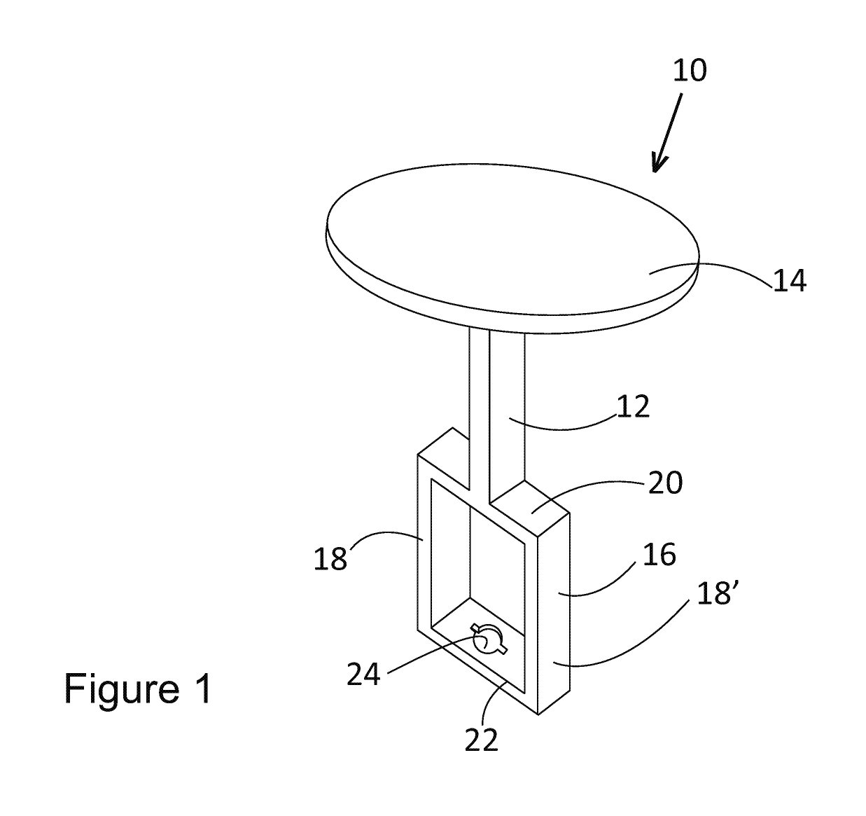

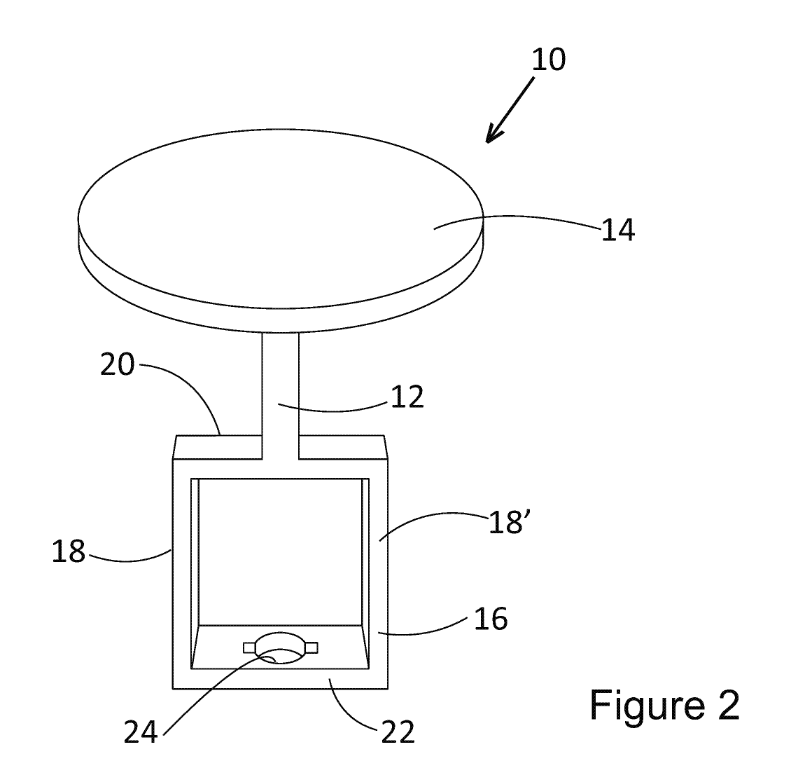

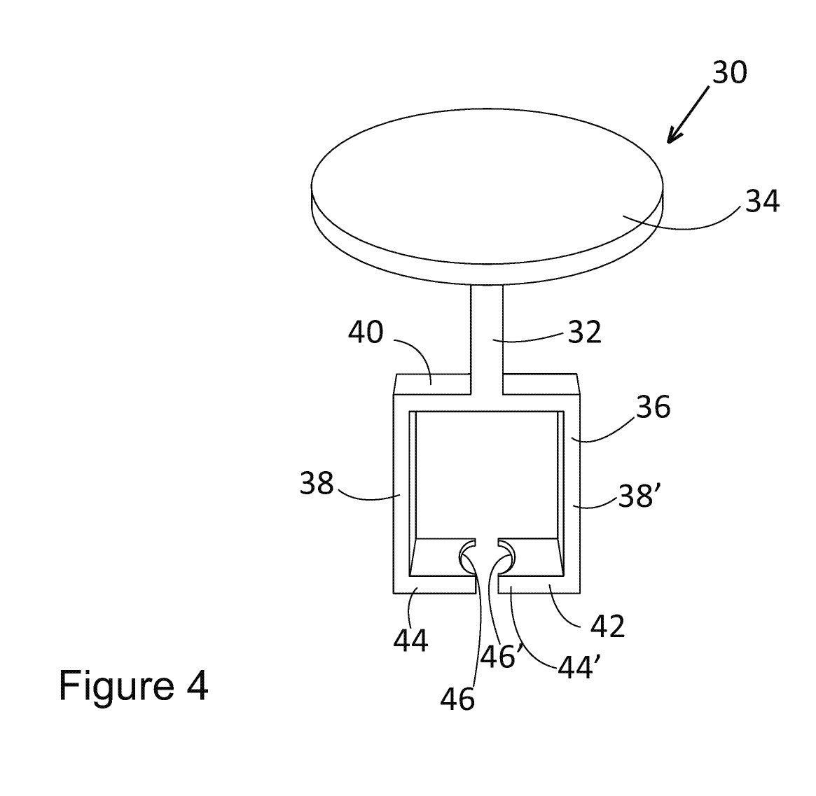

Two embodiments of the disclosed inventive concept are illustrated in the accompanying figures. One embodiment is illustrated in FIGS. 1 through 3 and another embodiment is illustrated in FIGS. 4 and 5. However, these embodiments are intended as being illustrative and non-limiting.

Referring to FIGS. 1, 2 and 3, a stud-engaging engine cover pocket plug, generally illustrated as 10, is shown in isolation. As noted, the illustrated configuration of the stud-engaging engine cover pocket plug 10 as shown in the figures is only suggestive and is not intended as being limiting. The stud-engaging engine cover pocket plug 10 may be formed from any of several polymerized materials. The stud-engaging engine cover pocket plug 10 includes a body 12 to which is connected at one end a substantially planar top 14 and at the opposite end to an attachment assembly 16. The outer surface of the planar top 14 is the visible surface when the stud-engaging engine cover pocket plug 10 is in place in the engine cover.

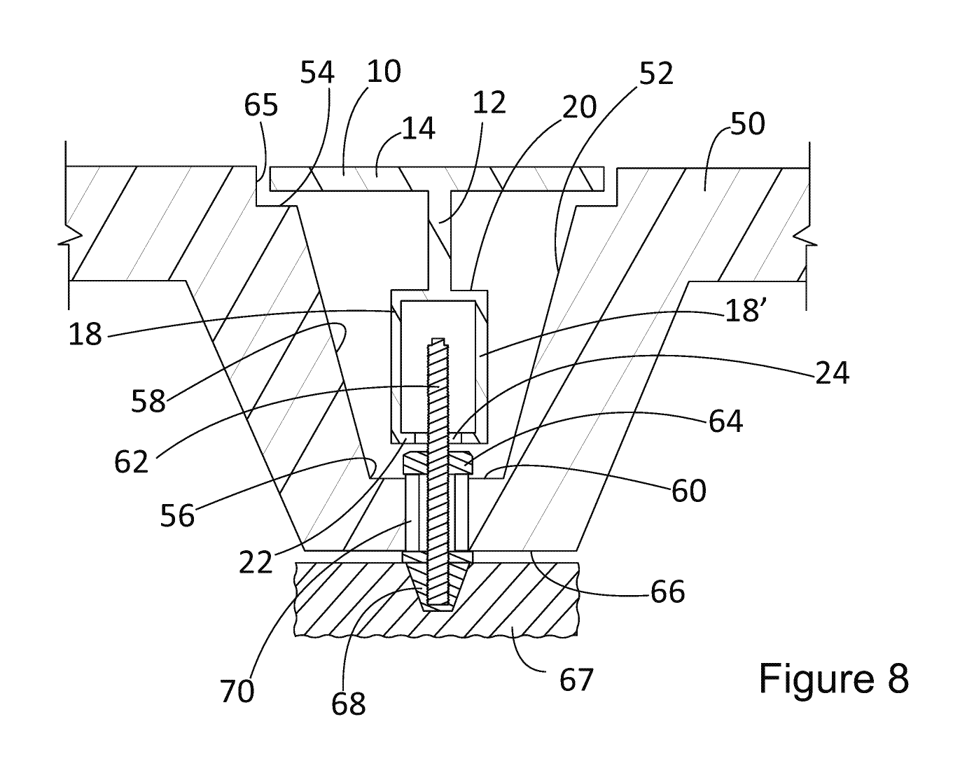

The attachment assembly 16 of the stud-engaging engine cover pocket plug 10 includes a retention feature that attaches the stud-engaging engine cover pocket plug 10 to an assembly stud discussed below with respect to FIG. 8. The attachment assembly 16 includes a first wall or leg 18, a second wall or leg 18′, and a top 20. One end of each of the legs 18 and 18′ is attached to the top 20 which is itself attached to the body 12. According to the embodiment presented in FIGS. 1, 2 and 3, a base 22 extends between the other end of each of the legs 18 and 18′. A retention feature in the form of a stud-retaining aperture 24 is formed in the middle of the base 22.

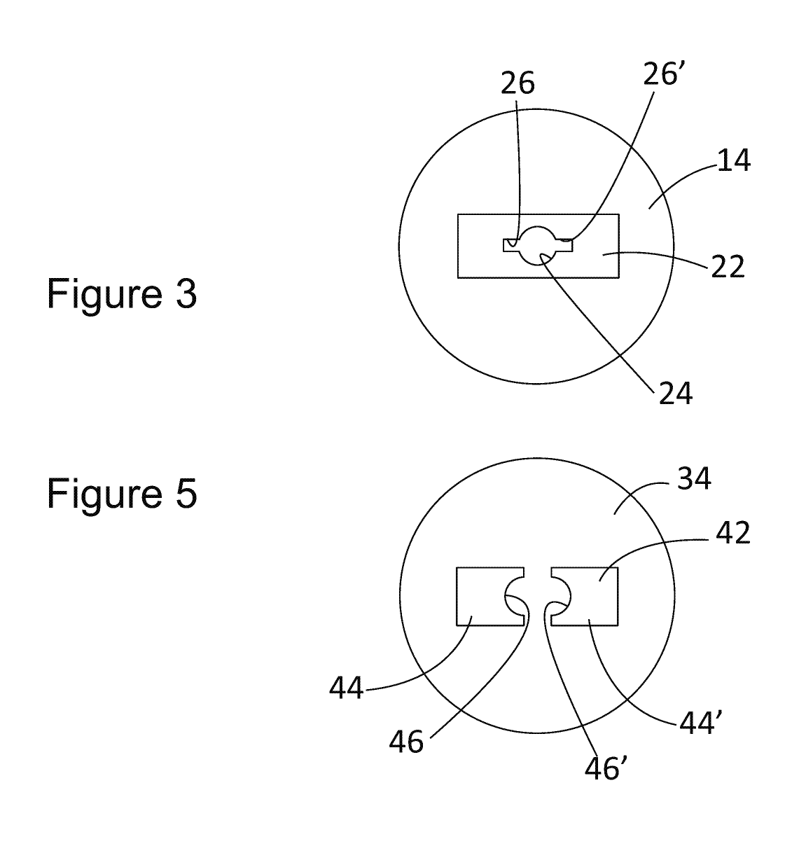

Referring specifically to FIG. 3, an underside view of the stud-engaging engine cover pocket plug 10 is illustrated. This view illustrates details of the stud-retaining aperture 24 which includes a pair of opposed slots 26 and 26′ that extend outward from the stud-retaining aperture 24 along the long axis of the base 22. The opposed slots 26 and 26′ function as relief for the force generated when the stud-engaging engine cover pocket plug 10 is pushed on to the stud.

Referring to FIGS. 4 and 5, a stud-engaging engine cover pocket plug, generally illustrated as 30, is shown in isolation according to another embodiment of the disclosed inventive concept. As noted, the illustrated configuration of the stud-engaging engine cover pocket plug 30 as shown in the figures is only suggestive and is not intended as being limiting. Like the stud-engaging engine cover pocket plug 10, the stud-engaging engine cover pocket plug 30 may be formed from any of several polymerized materials.

The stud-engaging engine cover pocket plug 30 includes a body 32 to which is connected at one end a substantially planar top 34 and at the opposite end to an attachment assembly 36. The outer surface of the planar top 34 is the visible surface when the stud-engaging engine cover pocket plug 30 is in place in the engine cover. The attachment assembly 36 of the stud-engaging engine cover pocket plug 30 includes a retention feature that attaches the stud-engaging engine cover pocket plug 30 to an assembly stud again discussed below with respect to FIG. 8.

The attachment assembly 36 includes a first wall or leg 38, a second wall or leg 38′, and a top 40. One end of each of the legs 38 and 38′ is attached to the top 40 which is itself attached to the body 32. According to the embodiment presented in FIGS. 4 and 5, a base 42 extends between the other end of each of the legs 38 and 38′. The base 42 comprises a first arm 44 attached to the leg 38 and a second arm 44′ attached to the leg 38′. A retention feature including a stud-retaining wall 46 formed on the end of the first arm 44 and a stud-retaining wall 46′ formed on the end of the second arm 44′ functions to holds the stud-engaging engine cover pocket plug 30 in place on the attachment stud.

Referring specifically to FIG. 5, an underside view of the stud-engaging engine cover pocket plug 30 is illustrated. This view illustrates details of the base 42, the arms 44 and 44′, and the stud-retaining walls 46 and 46′. The opposed arms 44 and 44′ function as relief for the force generated when the stud-engaging engine cover pocket plug 30 is pushed on to the stud.

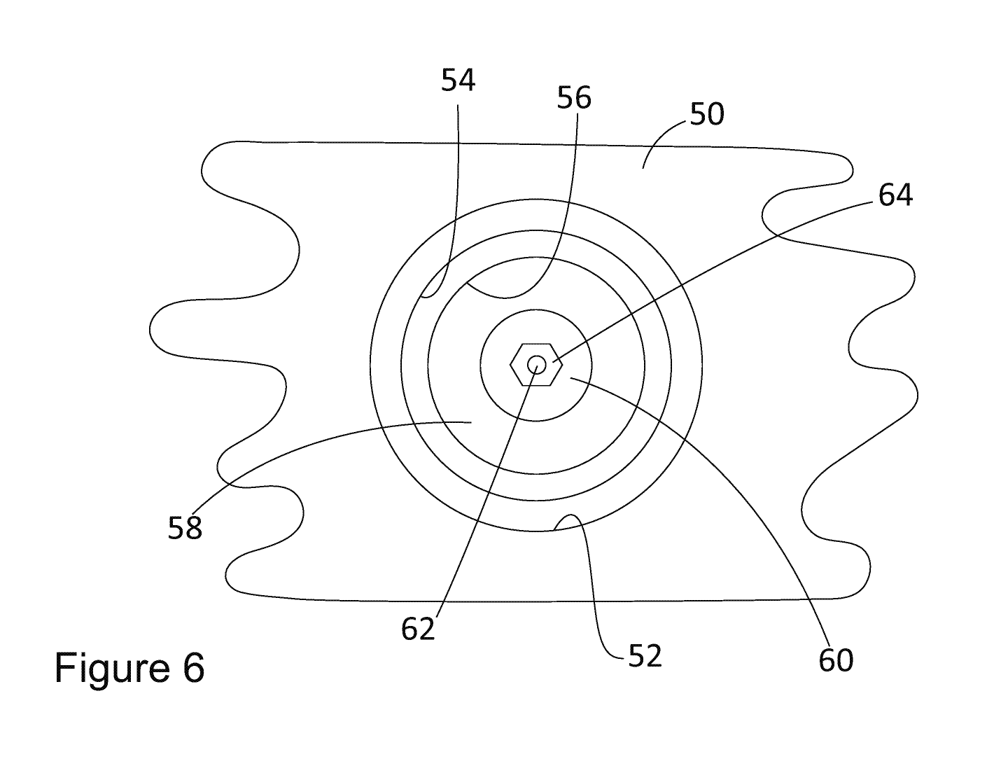

Referring to FIG. 6, a top view of a portion of an engine cover 50 having a fastener pocket 52 is illustrated. As is known, the engine cover 50 may be made from any of several materials including, without limitation, polyurethane. Several fastener pockets may be formed in the engine cover 50 though only a fastener pocket 52 is illustrated for the sake of simplicity.

The fastener pocket 52 includes an upper shoulder 54 and a lower shoulder 56. A conical wall 58 is formed between the lower shoulder 56 and a base wall 60 formed at the lower end of the fastener pocket 52. While a variety of methods mechanically fastening the engine cover 50 to the engine may be used, a preferred method is illustrated as including an engine cover stud 62 onto which a fastening nut 64 may be threaded.

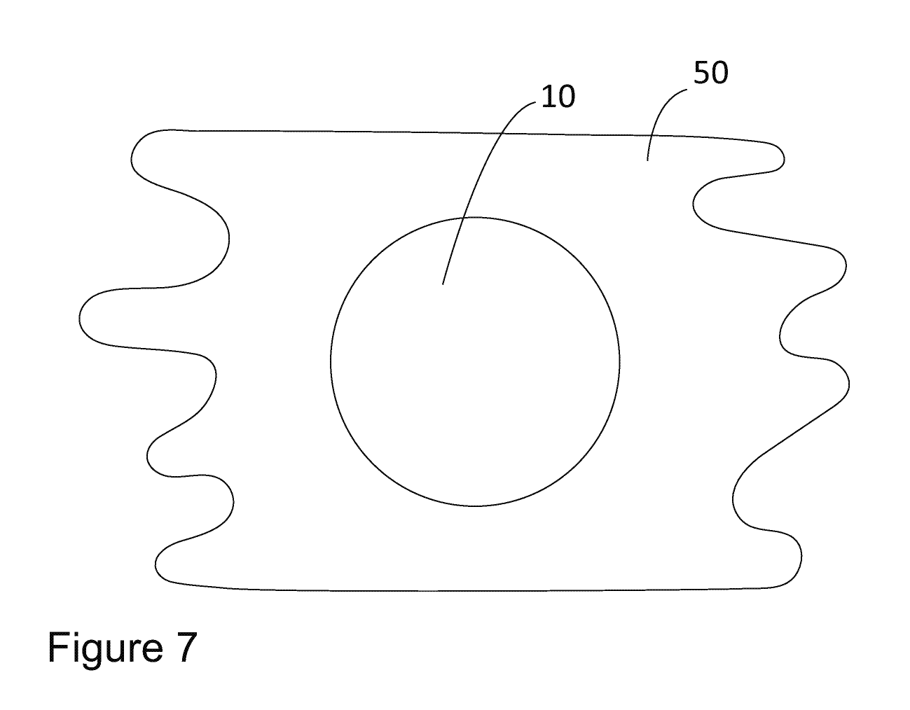

Referring to FIG. 7, a top view of a portion of the engine cover 50 is also illustrated. However, in this view, the stud-engaging engine cover pocket plug 10 (or 30) has been securely fitted into the fastener pocket 52. As illustrated in FIG. 7, the presence of the stud-engaging engine cover pocket plug 10 gives the engine cover 50 a finished and clean look without compromising the removability of the engine cover 50. The stud-engaging engine cover pocket plug 10 may be readily installed into the fastener pocket 52 upon vehicle assembly or following engine servicing. When engine service is required, the service technician may easily remove the stud-engaging engine cover pocket plug 10 by rotating the planar top 14 in a counter-clockwise direction (assuming the stud is a right-hand thread). To this end, the planar top 14 may be marked with an arrow and one or both of the words “off” and “on.”

A sectional view of the stud-engaging engine cover pocket plug 10 installed in the fastener pocket 52 and the accompanying fastening hardware is illustrated in FIG. 8. With reference thereto, the fastener pocket 52 includes an upper recess 65 defined by the upper shoulder 54. The conical wall 58 is formed between the upper shoulder 54 and the base wall 60.

The engine cover 50 includes bottom wall 66 formed on the underside of the fastener pocket 52. When in position, the engine cover 50 is fitted adjacent an engine block 67. A fastener anchor 68 is attached to the engine block 67 into which the engine cover stud 62 is threaded or is otherwise attached. The nut 64 is threaded onto the upper end of the engine cover stud 62. A spacer 70 is fitted between the underside of the nut 64 and the upper side of the fastener anchor 68. The spacer 70 also functions as a load limiter. With the spacer 70 in place, a gap is preferably defined between the engine block 67 and the bottom wall 66 of the cover 50.

The stud-engaging engine cover pocket plug 10 is retained in position within the fastener pocket 52 by an embodiment of the retention feature discussed above. Particularly, and referring to the embodiment illustrated in FIGS. 1-3, the stud-retaining aperture 24 is threadably retained on the stud 62. As noted above, the pair of opposed slots 26 and 26′ function as relief for the force generated when the stud-engaging engine cover pocket plug 10 is pushed on to the stud. Referring to the embodiment illustrated in FIGS. 4 and 5, the stud-retaining walls 46 and 46′ of the arms 44 and 44′ respectively hold to the stud 62 while also providing relief for the force generated when the stud-engaging engine cover pocket plug 10 is pushed on to the stud. The stud-engaging engine cover pocket plug 10 is thus held securely within the pocket 52 until a repair technician selects to remove the plug 10 from the pocket 52 for servicing. Regardless of the embodiment, when the stud-engaging engine cover pocket plug 10 is being installed, the upper recess 65 of the fastener pocket 52 restricts downward movement of the stud-engaging engine cover pocket plug 10.

A fluid-tight seal is formed when the stud-engaging engine cover pocket plug 10 is in position within the pocket 52. The fluid-tight seal prevents water, oil and debris from accumulating in the pocket 52 and near the fastener assembly. The stud-engaging engine cover pocket plug 10 may be reused repeatedly.

One skilled in the art will readily recognize from such discussion, and from the accompanying drawings and claims that various changes, modifications and variations can be made therein without departing from the true spirit and fair scope of the invention as defined by the following claims.

What is claimed is:

1. A removable plug for use with an engine cover having a fastener pocket, the engine cover being attachable to an engine with a fastener, the plug comprising:
a body having first and second ends;
a cover attached to said first end;
a stud attachment assembly attached to said second end, said assembly comprising a bridge, a pair of spaced apart legs attached to said bridge, and a base, said base including a stud-retaining aperture.

2. The removable plug for use with an engine cover of claim 1, wherein said bridge, said pair of spaced apart legs, and said base define a parallelogram.

3. The removable plug for use with an engine cover of claim 2, wherein said parallelogram is a rectangle.

4. The removable plug for use with an engine cover of claim 1, wherein said cover has an outer top surface, said surface being substantially planar.

5. The removable plug for use with an engine cover of claim 1, said base has a center and said stud-retaining aperture is formed in said center.

6. The removable plug for use with an engine cover of claim 1, wherein said base has a long axis, said base including a pair of opposed slots extending from said stud-retaining aperture in opposite directions along said long axis of said base.

7. The removable plug for use with an engine cover of claim 1, wherein said base has a long axis, said base including a pair of opposed slots extending from said stud-retaining aperture, each slot extending in a direction that is perpendicular to said long axis of said base.

8. A removable plug for use with an engine cover having a fastener pocket, the engine cover being attachable to an engine with a fastener, the plug comprising:
a body having first and second ends;
a cover attached to said first end;
a stud attachment assembly associated with said second end, said assembly comprising an elongated body, said body including a stud-retaining aperture.

9. The removable plug for use with an engine cover of claim 8, wherein said elongated body includes a bridge, a pair of spaced apart legs attached to said bridge, and a base, said base including said stud-retaining aperture.

10. The removable plug for use with an engine cover of claim 9, wherein said bridge, said pair of spaced apart legs, and said base define a parallelogram.

11. The removable plug for use with an engine cover of claim 10, wherein said parallelogram is a rectangle.

12. The removable plug for use with an engine cover of claim 10, wherein said cover has an outer top surface, said surface being substantially planar.

13. The removable plug for use with an engine cover of claim 8, said base has a center and said stud-retaining aperture is formed in said center.

14. The removable plug for use with an engine cover of claim 8, wherein said base has a long axis, said base including a pair of opposed slots extending from said stud-retaining aperture in opposite directions along said long axis of said base.

15. The removable plug for use with an engine cover of claim 8, wherein said base has a long axis, said base including a pair of opposed slots extending from said stud-retaining aperture, each slot extending in a direction that is perpendicular to said long axis of said base.

16. A cover assembly for use with a vehicle engine comprising:
a cover having a fastener pocket;
a fastener assembly having a stud for attaching said cover to the engine; and
a plug for removable insertion into said pocket, said plug including a concealing cover and a stud attachment assembly extending from said cover, said assembly comprising a bridge, a pair of spaced apart legs attached to said bridge, and a base having a stud-retaining aperture.

17. The cover assembly for use with a vehicle engine of claim 16, wherein said bridge, said pair of spaced apart legs, and said base define a parallelogram, said plug further including a body extending from said cover to said stud attachment assembly.

18. The removable plug for an engine cover of claim 16, wherein said base has a long axis, said base including a pair of opposed slots extending from said stud-retaining aperture in opposite directions along said long axis of said base.

19. The removable plug for an engine cover of claim 16, wherein said base has a long axis, said base including a pair of opposed slots extending from said stud-retaining aperture, each slot extending in a direction that is perpendicular to said long axis of said base.

20. The removable plug for an engine cover of claim 16, further including a fastener anchor attached to the engine for receiving stud, said fastener anchor having an upper surface, the assembly further including a compression limiting spacer positioned between said upper surface of said fastener anchor and said nut.
